(19) United States
(12) Patent Application Publication
(10) Pub. No.: US 2012/0258666 A1
(43) Pub. Date: Oct. 11, 2012

(54) WIRELESS COMMUNICATION APPARATUS AND METHOD

(75) Inventors: Hideo KASAMI, Yokohama-shi (JP); Kiyoshi TOSHIMITSU, Tokyo (JP); Koichiro BAN, Kawasaki-shi (JP); Tomoya HORIGUCHI, Inagi-Shi (JP)

(73) Assignee: KABUSHIKI KAISHA TOSHIBA, Tokyo (JP)

(21) Appl. No.: 13/421,582

(22) Filed: Mar. 15, 2012

Related U.S. Application Data
(63) Continuation of application No. PCT/JP2009/066107, filed on Sep. 15, 2009.

(51) Int. Cl. H04W 24/00; H04B 7/00

(52) U.S. Cl. 455/41.2

(57) ABSTRACT

According to one embodiment, a wireless communication apparatus includes a determination unit, a first setting unit, a second setting unit and a wireless unit. The determination unit determines whether a signal degradation degree is higher than a threshold value. The first setting unit sets first parameters relating to a first data rate and a first communication robustness. The second setting unit sets second parameters relating to a second data rate and a second communication robustness if an instruction signal is received and if the signal degradation degree is higher than the threshold value. The wireless unit communicates with a communication partner using one of the first parameters and the second parameters.

### CROSS-REFERENCE TO RELATED APPLICATIONS

This application is a Continuation Application of PCT Application No. PCT/JP2009/066107, filed Sep. 15, 2009, the entire contents of which are incorporated herein by reference.

### FIELD

Embodiments described herein relate generally to a wireless communication apparatus and method.

### BACKGROUND

Some conventional close-proximity wireless communication schemes assume that multipaths are not generated at the time of communications. A communication apparatus includes a contact detection unit which detects contact with a communication partner. If the contact detection unit detects contact, the communication is regarded as close-proximity wireless communication. The communication apparatus performs high-speed transmission using a wireless communication scheme susceptible to a multipath but having a high data rate. Conversely, if the contact detection unit detects noncontact, the communication is regarded as non-close-proximity wireless communication. The communication apparatus performs low-speed transmission using a wireless communication scheme resistant to the multipath but having a low data rate (See, e.g., JP-A. No. 2007-235605 (KOKAI)).

### BRIEF DESCRIPTION OF THE DRAWINGS

FIG. 1 is a conceptual diagram of a method of using a wireless communication apparatus according to the first embodiment.

FIG. 2 is a block diagram illustrating the wireless communication apparatus according to the first embodiment.

FIG. 3 is a diagram illustrating an example of a wireless communication frame format.

FIG. 4 is a block diagram illustrating an example of a signal input to an activation unit and a signal degradation degree output from a wireless unit.

FIG. 5 is a diagram illustrating an example of frame parameters.

FIG. 6 is a table illustrating an example of transmission efficiency comparison according to FFT point counts.

FIG. 7 is a graph illustrating the sidelobe levels corresponding to the FFT point counts.

FIG. 8 is a graph illustrating the total calculation amount of reception FFT processing as a function of FFT point counts.

FIG. 9 is a graph illustrating an example of effective speed comparison as a function of FFT point counts.

FIG. 10 is a flowchart showing the control operation if data is transferred from a station to a terminal.

FIG. 11 is a flowchart showing the threshold value determination using a receiving packet error count.

FIG. 12 is a flowchart showing the control operation if data is transferred from the terminal to the station.

FIG. 13 is a flowchart showing the threshold value determination using a transmitting packet error count.

FIG. 14 is a conceptual diagram of a method of using a wireless communication apparatus according to the second embodiment.

FIG. 15 is a block diagram illustrating the wireless communication apparatus according to the second embodiment.

FIG. 16 is a block diagram illustrating an example of a timer.

FIG. 17 is a flowchart showing the operation when data is transferred from a station to a terminal according to the second embodiment.

FIG. 18 is a block diagram illustrating a wireless communication apparatus according to the third embodiment.

FIG. 19 is a block diagram illustrating a timer according to the third embodiment.

FIG. 20 is a block diagram illustrating another example of the wireless communication apparatus according to the third embodiment.

FIG. 21 is a graph illustrating the maximum delay time measurement values of delay waves caused by multipaths.

FIG. 22 is a diagram illustrating a demodulator according to the third embodiment.

### DETAILED DESCRIPTION

A propagation loss is high at a high carrier frequency such as a millimeter wave. A multipath can be generated even in close-proximity wireless communication, resulting in unstable communication. Even if the communication apparatus is performing communication using high-speed transmission at the time of contact detection, the communication apparatus may not substantially perform high-speed transmission. Conversely, although the communication apparatus performs communication using low-speed transmission at the time of contact nondetection in favor of stability, the communication apparatus may perform communication using high-speed transmission. In described above case, conventional techniques cannot cope with switching from low-speed transmission to high-speed transmission.

In general, according to one embodiment, a wireless communication apparatus includes a determination unit, a first setting unit, a second setting unit and a wireless unit. The determination unit is configured to determine whether or not a signal degradation degree of a wireless communication is higher than a threshold value, the signal degradation degree indicating a degradation degree of a signal quality. The first setting unit is configured to set first parameters if communicating with a communication partner, the first parameters relating to a first data rate and a first communication robustness. The second setting unit is configured to set second parameters if an instruction signal is received from a upper layer and if the signal degradation degree is higher than the threshold value during performing the wireless communication with the communication partner using the first parameters, the second parameters relating to a second data rate and a second communication robustness, the second data rate being lower than the first data rate, the second communication robustness being higher than the first communication robustness. The wireless unit is configured to communicate with the communication partner using the first parameters or the second parameters.

A wireless communication apparatus according to the present embodiment will be described in detail with reference to the accompanying drawings. Note that the same reference numbers in the following embodiments denote the same operations, and description will not be repeated.

### FIRST EMBODIMENT

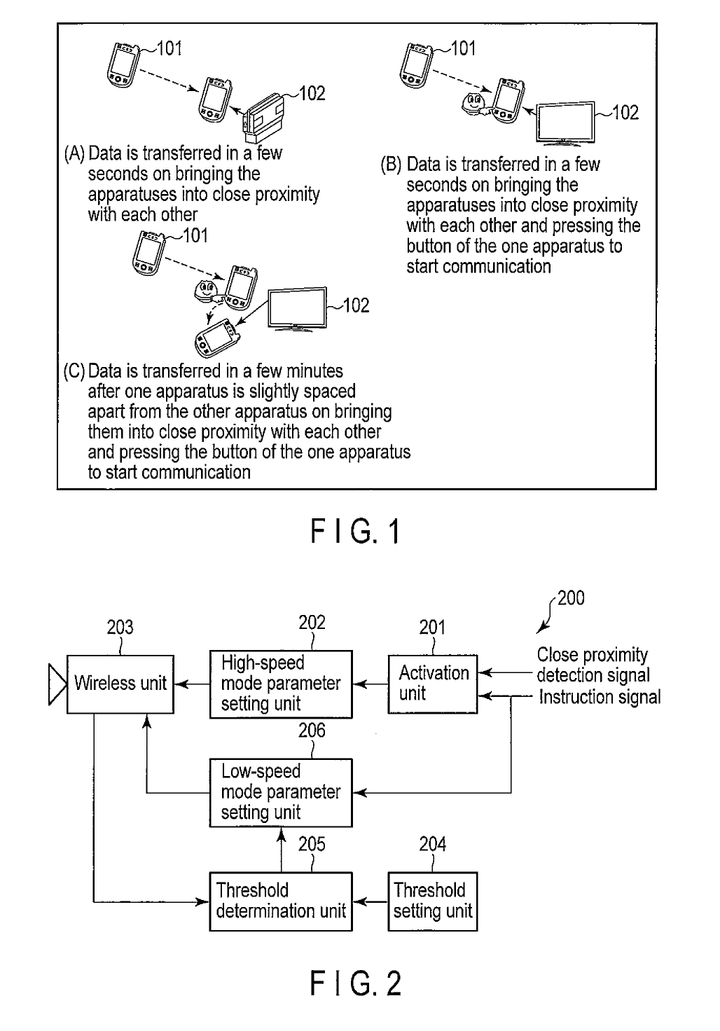

An example of using a wireless communication apparatus according to a first embodiment will be described in detail with reference to FIG. 1.

It is assumed that the wireless communication apparatus according to this embodiment is used in each of a terminal 101 and a station 102. A indicates a case in which data is transferred in a few seconds (to be also referred to as instantaneous transfer) when the terminal 101 and the station 102 are brought into close proximity to each other. Examples of the terminal 101 are a cellular phone, personal digital assistant (PDA), and the like. The station 102 is an apparatus which stores content data such as a text and video data and transmits data in response to a request from the terminal in this embodiment. Examples of the station 102 are an automatic ticket gate, TV, and the like. In case A, the terminal 101 and the station 102 communicate by near-field communication (NFC) scheme, respectively, and small-size text data is instantaneously transferred from the station 102 to the terminal 101. Case A assumes that a communication close-proximity detection which allows instantaneous transfer is several ten centimeters between the terminal 101 and the station 102.

B is a case in which the user presses a button of the terminal 101 to perform instantaneous transfer after the terminal 101 is brought into close proximity to the station 102. In this case, the station 102 does not include an NFC scheme. Upon performing a specific operation such as pressing a button of the terminal 101 as a trigger, data having a relatively small size such as web content is instantaneously transferred from the station 102 to the terminal 101. Case B assumes this situation.

C is a case in which data is transferred in a few minutes after the terminal 101 is slightly spaced apart from the station 102 upon bringing the terminal 101 into close proximity to the station 102 and pressing the button of the terminal 101 to start communication. In this case, the station 102 does not include any NFC scheme as in case B. Since it is assumed that data having a relatively large size such as video content is transferred from the station 102, the user presses the button while holding the terminal 101, and may leave from the terminal 101 while placing the terminal 101 in another location. While the user is holding the terminal 101, the communication state is good to allow high-speed communication. However, if the user places the terminal 101 in another location away from the place where the user holds the terminal 101, the communication state may become poor. Case C assumes this situation.

The communication between the terminal 101 and the station 102 in FIG. 1 assumes that data is transmitted from the station 102 and the terminal 101 receives the data such as content. However, the communication is not limited to this. The terminal 101 may transmit data such as content and the station 102 may receive this data. Alternatively, data may be exchanged between the terminals 101 and between the terminal 101 and another digital apparatus such as a PC, information KIOSK®, or the like.

The arrangement of a wireless communication apparatus according to this embodiment will be described in detail with reference to FIG. 2.

A wireless communication apparatus 200 includes an activation unit 201, high-speed mode parameter setting unit 202, wireless unit 203, threshold setting unit 204, threshold determination unit 205, and low-speed mode parameter setting unit 206.

The activation unit 201 outputs an activation signal upon receiving of at least one of a close-proximity detection signal and an instruction signal from external. The close-proximity detection signal is a signal indicating that a distance between communication apparatuses has reached in a close-proximity distance. The close-proximity distance indicates a distance by which communication is started if the distance between communication apparatuses fell within a predetermined distance. The instruction signal is a signal which detects a specific instruction to the communication apparatus. More specifically, the instruction signal includes a signal which detects a specific operation from the user to the apparatus such that the user presses a button, or a signal which detects an automatic start instruction supplied from another system to the wireless communication apparatus. These two signals are signals sent from the wireless communication apparatus via an upper layer and defined together as the instruction signal. The close-proximity detection signal and the instruction signal will be described with reference to FIG. 4.

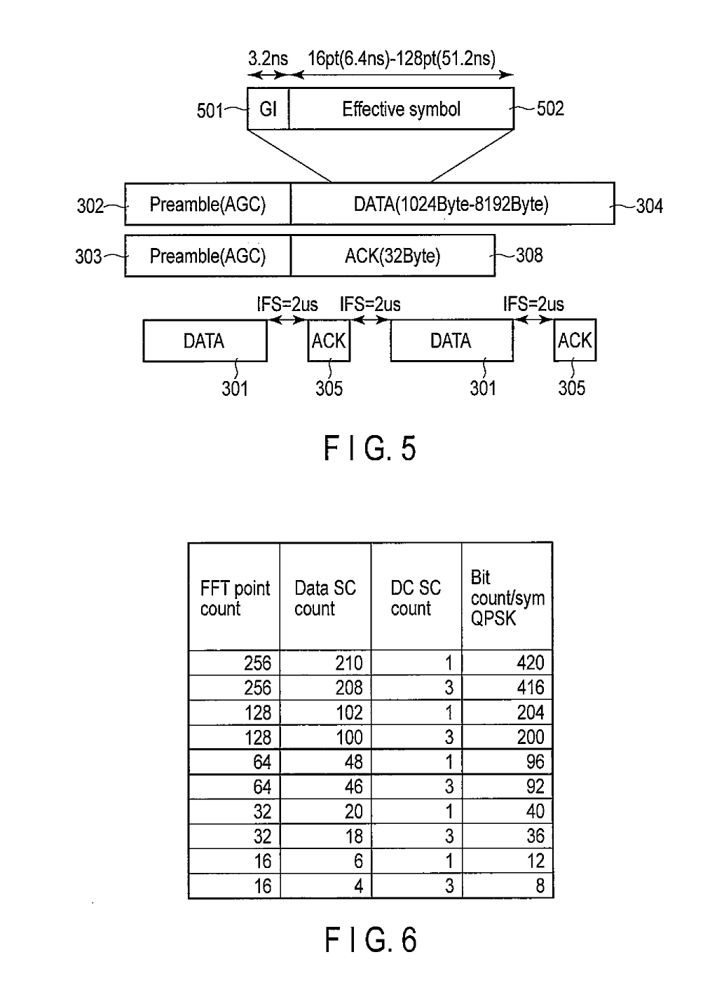

The high-speed mode parameter setting unit 202 receives an activation signal from the activation unit 201 and sets high-speed mode parameter setting values. High-speed mode represents high-speed transmission enable settings in which the symbol rate and data rate are high, but communication robustness is relatively low. The communication robustness is robustness over interference (e.g., multipath). High-speed mode design will be described later with reference to FIGS. 5, 6, 7, 8, and 9.

The wireless unit 203 receives the high-speed mode parameter setting values from the high-speed mode parameter setting unit 202 and performs wireless communication in high-speed mode based on the parameter setting values. The wireless unit 203 calculates signal degradation degree every predetermined interval. The signal degradation degree is an index indicating the communication propagation state and will be described later with reference to FIG. 4. Upon receiving low-speed mode parameter setting values from the low-speed mode parameter setting unit 206 (to be described in detail later), the wireless unit 203 performs wireless communication upon switching from high-speed mode to low-speed mode based on the low-speed mode parameter setting values. Low-speed mode represents low-speed transmission settings in which the symbol rate and data rate are lower than those of high-speed mode, but the communication robustness is higher than that of high-speed mode, thereby performing stable communication. Low-speed mode design will be described in detail later.

The threshold setting unit 204 sets a threshold value for determining whether or not the wireless communication is performed in high-speed mode or low-speed mode.

The threshold determination unit 205 receives the signal degradation degree from the wireless unit 203 and the threshold value from the threshold setting unit 204. The threshold determination unit 205 determines whether or not the signal quality is degraded, that is, whether or not the signal degradation degree is higher than the threshold value, thereby calculating determination values.

The low-speed mode parameter setting unit 206 receives a determination value indicating that the signal degradation degree is higher than the threshold value from the threshold determination unit 205 if the threshold determination unit 205 determines that the signal quality is degraded. At the same time, upon receiving a user operation detection signal, the low-speed mode parameter setting unit 206 sets the low-speed mode parameter setting values.

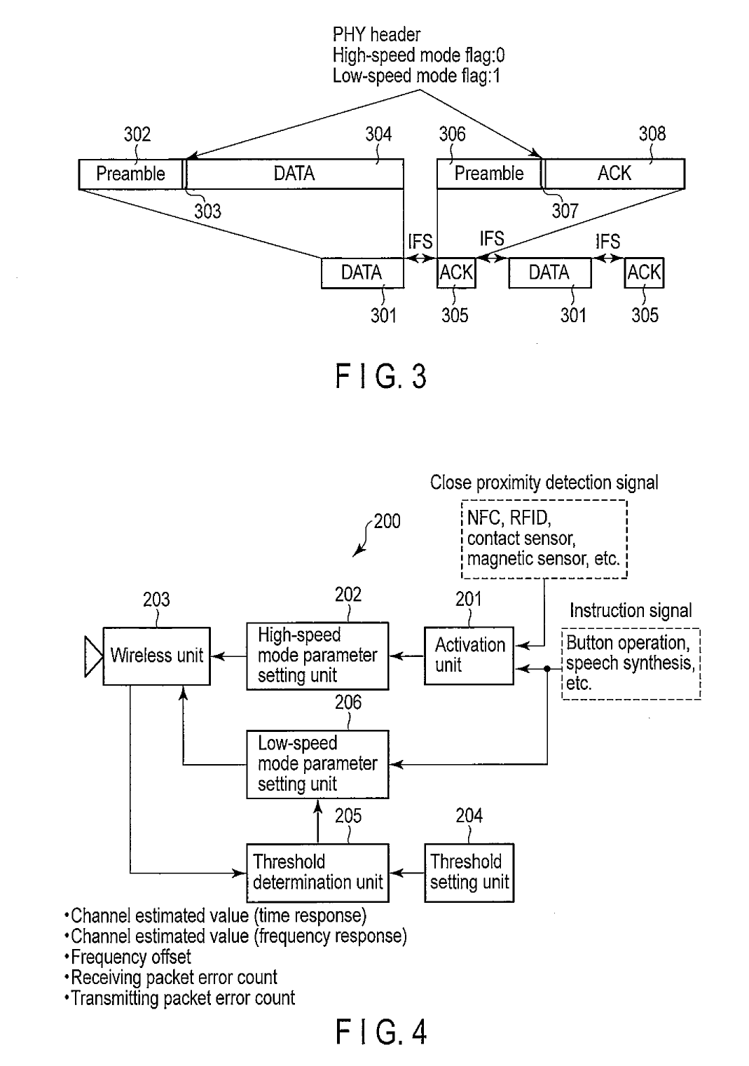

The frame format used in wireless communication in this embodiment will be described in detail with reference to FIG. 3.

A data packet (DATA) 301 and a response packet (ACK) 305 are communicated with an interval called an inter-frame space (IFS) between the terminal 101 and the station 102. The data packet 301 includes a preamble 302, PHY header 303, and data body 304. The response packet 305 similarly includes a preamble 306, PHY header 307, and ACK body 308. “High-speed mode flag: 0” and “low-speed mode flag: 1” serving as the flags for discriminating high-speed mode from low-speed mode are set in each of the PHY header 303 of the data packet 301 and the PHY header 307 of the response packet.

An example of an input signal to the activation unit 201 and an example of a signal degradation degree output from the wireless unit 203 in the wireless communication apparatus 200 of this embodiment will be described in detail with reference to FIG. 4.

Examples of a method of obtaining a close-proximity detection signal are detection using NFC, detection using RFID (Radio Frequency IDentification), detection using a contact sensor, and detection using a magnetic sensor. Since these methods are general methods, and a detailed description thereof will not be repeated. One of these methods or a combination of a plurality of these methods can be used to generate a close-proximity detection signal. Examples of a method of obtaining an instruction signal may be a method of generating an instruction signal when the user presses a specific button and may be a method of generating an instruction signal by speech recognition. Alternatively, an instruction which allows the wireless communication apparatus to communicate with a communication partner at a given date and time may be embedded in an upper application (upper layer) and sent to the activation unit 201 as an instruction signal.

Examples of the signal degradation degree output from the wireless unit 203 and used in threshold value determination in the threshold determination unit 205 are a time response of a channel estimation value, a frequency offset, a frequency response of the channel estimation value, a receiving packet error count, and a transmitting packet error count.

If the time response of the channel estimation value is used in the threshold value determination, a threshold value is set for the maximum delay time of a delay wave caused by a multipath. If the maximum delay time exceeds the threshold value, the mode is triggered and switched to low-speed mode.

If the frequency response of the channel estimation value is used in the threshold value determination, a threshold value is set for a difference between the maximum amplitude value and the minimum amplitude value of the frequency response caused by the multipath. If the difference exceeds the threshold value, the mode is triggered and switched to low-speed mode.

If the frequency offset estimation value is used in threshold value determination, a threshold value is set for a difference (shift) of the clock frequencies between the wireless communication apparatuses. If the difference of the clock frequency increases, communication using the OFDM scheme adversely affects demodulation. Therefore, if the difference exceeds the threshold value, the mode is triggered and switched to low-speed mode. The frequency offset can be estimated from the preambles 302 and 306 shown in FIG. 3.

Assume that the receiving packet error count or transmitting packet error count is used in threshold value determination. In this case, if the receiving packet error count or transmitting packet error count exceeds the threshold value, the mode is triggered and switched to low-speed mode.

The design aspects of the high-speed mode parameter setting values will be described in detail with reference to FIGS. 5, 6, 7, 8, and 9.

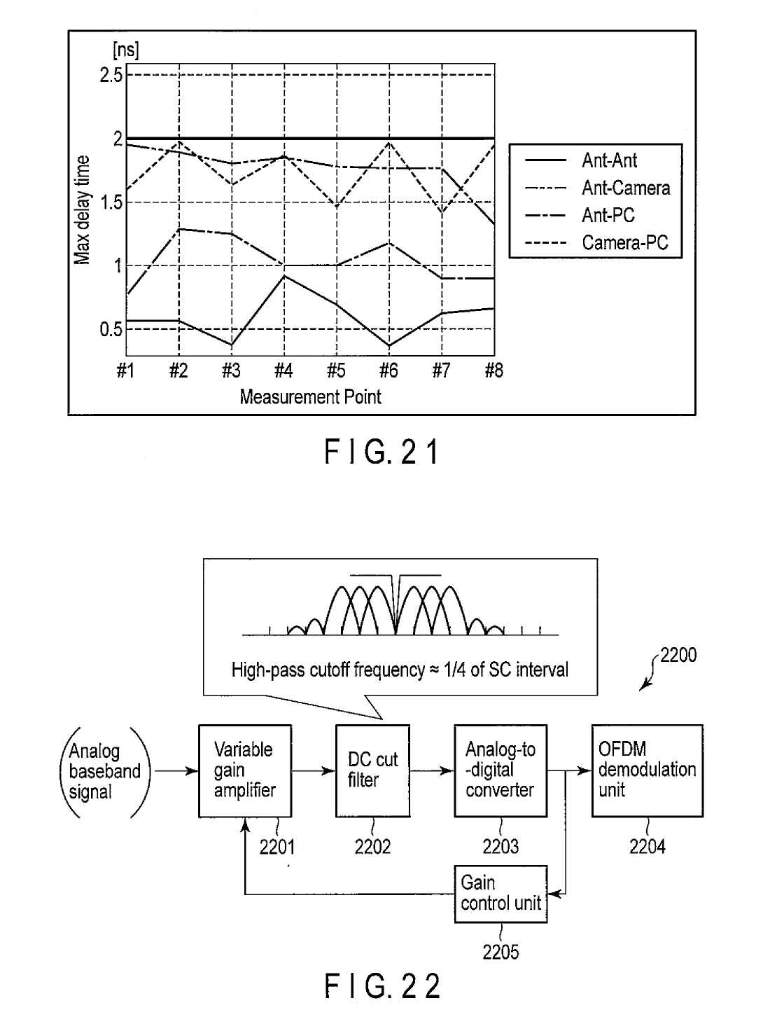

Assume that the carrier frequency used in the wireless unit 203 is a millimeter waveband, that an antenna of the wireless unit 203 is built in the apparatus, and that the communication range is about 10 cm. The modulation scheme is fast Fourier transform (FFT) 64-point size orthogonal frequency division multiplexing (OFDM). The OFDM guard interval length is 2 ns or more in consideration of the measurement results in FIG. 21 (to be described later). If the guard interval length increases excessively, the data rate undesirably decreases. In this embodiment, the upper limit of the guard interval length is set to 6.4 ns for the following reason.

The point count of the guard interval is desirably set to an integer multiple of the digital signal processing parallel count. Conversely, since the signal band of one 60-GHz channel defined by the Radio Law is 2.5 GHz. It suffices to assume 2.5 GHz (0.4 ns) as a sampling rate. In this case, the digital signal processing parallel count is a maximum of a parallel count of 16 (156.25 MHz) in practice. For this reason, the upper limit of the guard interval length is set to 6.4 ns=0.4 ns×16 points. FIG. 5 shows frame parameters in high-speed mode. The IFS length is set to 2 μs, the guard interval (GI) 501 is set to 3.2 ns, and the effective symbol 502 falls the range from 16 points (6.4 ns) to 128 points (51.2 ns).

The reason why the FFT point count of 64 is optimum will be described below from the viewpoints of low power consumption and high-speed operation.

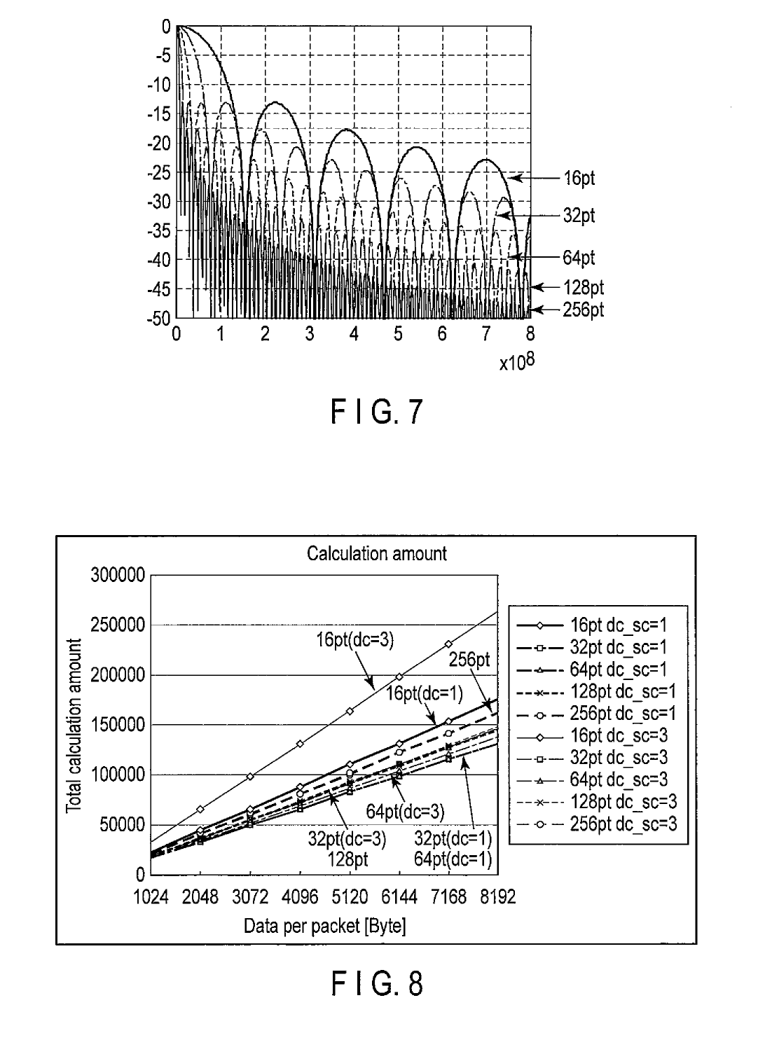

FIG. 6 shows the transmission efficiency comparison according to the FFT point counts. In this case, the sampling rate is set to 2.5 GHz, and QPSK is used as subcarrier modulation. Error correction coding is not performed because high-speed communication is aimed at. As shown in FIG. 7, the data subcarrier count is adjusted such that the third sidelobe level of the subcarrier at the signal band end is kept unchanged regardless of the FFT point counts.

FIG. 6 shows the data subcarrier (Data SC) counts, DC component null subcarrier (DC SC) counts, and bit counts per symbol in QPSK in correspondence with the FFT point counts. A decrease in FFT point count reduces the transmission efficiency and makes it difficult to perform high-speed transmission.

FIG. 8 shows the total calculation amount comparison of the reception FFT processing as a function of the FFT point counts. As shown in FIG. 8, 64-point FFT and 32-point FFT (the null subcarrier counts of the DC components of both cases are 1 each) are optimal from the viewpoint of the total calculation amount of the receiving FFT processing.

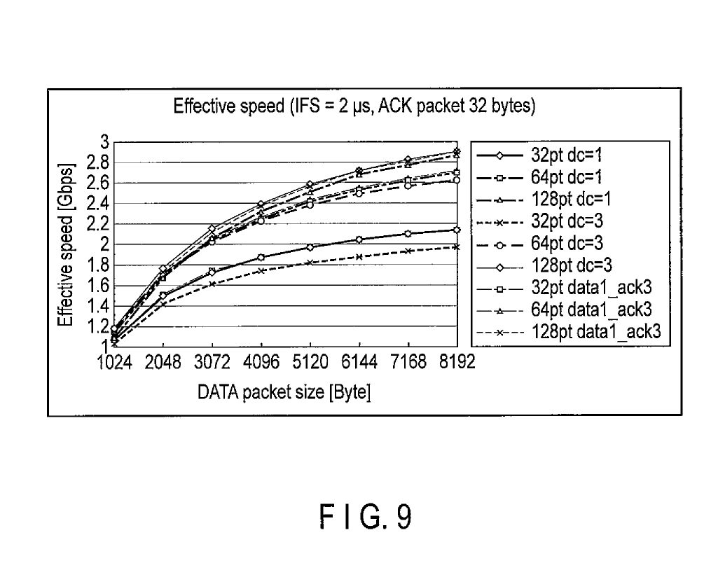

FIG. 9 shows the effective speed comparison as a function of the FFT point counts. The comparison between 64-point FFT and 32-point FFT reveals that the 64-point FFT is better from the viewpoint of the effective speed. Therefore, 64 points are optimum as the FFT point count.

The low-speed mode design will be described below. Low-speed mode uses OFDM using 64-point FFT as in high-speed mode.

The following three examples are enumerated as low-speed mode.

a) The encoding rate of error correction coding decreases.

b) The same data is repeatedly sent.

c) The subcarrier affected by a multipath is not used.

The practical examples of decreasing the encoding rate of error correction coding of item a are a method not using puncture processing for a convolution code and a method of reducing an encoding length or data length for a Reed-Solomon code.

Examples of the method of repeatedly sending the same data of item b are OFDM symbol repetition and subcarrier repetition. In OFDM symbol repetition, at least two or more OFDM symbols are set identical. In subcarrier repetition, at least two or more subcarrier symbols in the OFDM symbols are set identical.

Examples of the method not using the subcarrier affected by the multipath in item c are a method not using consecutive subcarrier units and a method not using subcarrier units of a predetermined interval. More specifically, assume that the subcarriers are numbered as 1, 2, . . . , 63. If the consecutive subcarrier units are not used, the subcarriers 1, 2, . . . , 8 are not used. Conversely, if the subcarrier units of the predetermined interval are not used, the subcarriers 1, 9, 17, . . . , 56 are not used. Of the items a to c of low-speed mode, a method used as low-speed mode is not limited to one, but a combination of these methods may be used.

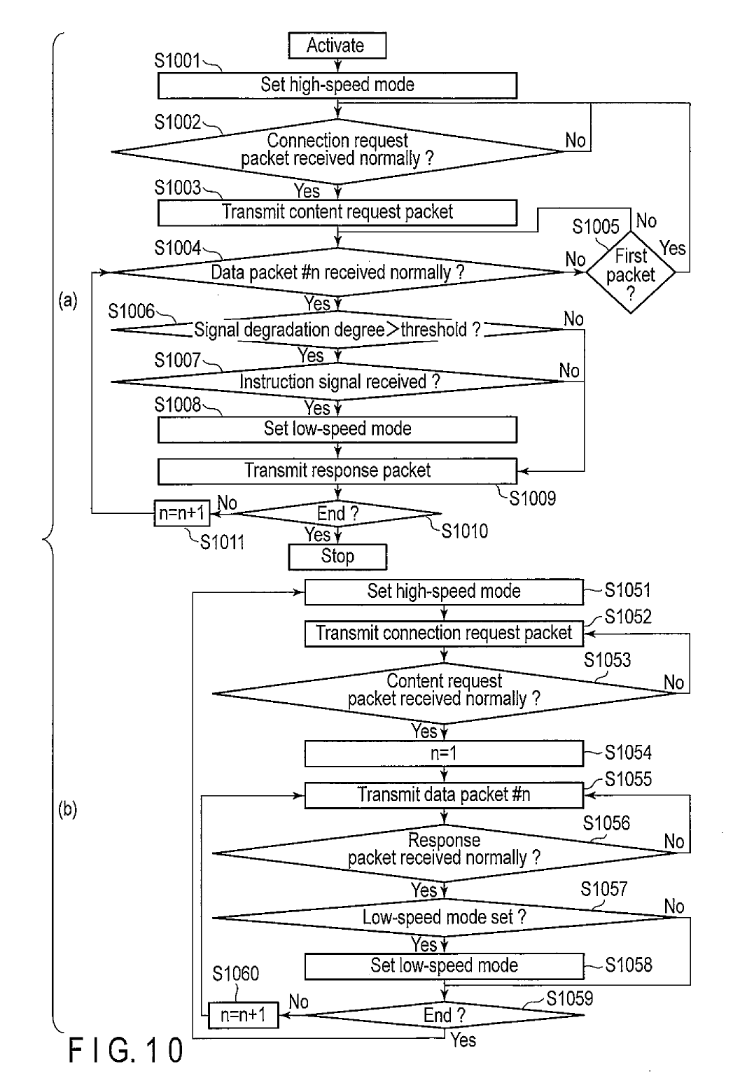

FIG. 10 is a flowchart showing the operation of the wireless communication apparatus 200 according to the first embodiment.

FIG. 10(a) shows the operation on the side of the terminal 101, while FIG. 10(b) shows the operation on the side of the station 102. Assume that data is transferred from the station 102 to the terminal 101. The operation of the terminal 101 will be described in detail with reference to the flowchart in FIG. 10(a).

First of all, the terminal 101 according to the wireless communication apparatus 200 is activated when either a close-proximity detection signal or instruction signal is input to the activation unit 201.

In step S1001, the wireless unit 203 sets the wireless communication in high-speed mode in accordance with the high-speed mode parameters from the high-speed mode parameter setting unit 202.

In step S1002, the wireless unit 203 determines whether or not a connection request packet has been received normally from a communication partner (in this case, the station 102). If the packet has been received normally, the process advances to step S1003; otherwise, step S1002 is repeated until a packet has been received.

In step S1003, the wireless unit 203 transmits a content request packet to the communication partner.

In step S1004, it is determined whether or not the wireless unit 203 has received the data packet normally. If the data packet has not been received normally, the process advances to step S1005; otherwise, the process advances to step S1006. When processing in step S1004 is performed for the first time, n is 1.

In step S1005, it is determined whether or not the data packet which cannot be received normally by the wireless unit 203 is the first data packet (data packet #1). If the packet is the first data packet, the process returns to step S1002 to repeat processing in steps S1002 to S1004. If the packet which cannot be received normally is not the first data packet, processing in step S1004 is repeated until the data packet has been received normally.

In step S1006, the threshold determination unit 205 compares the signal degradation degree from the wireless unit 203 with the threshold from the threshold setting unit 204 to determine whether or not the signal degradation degree is higher than the threshold value. If the signal degradation degree is higher than the threshold value, the process advances to step S1007; otherwise, the process advances to step S1009.

It is determined in step S1007 whether or not the low-speed mode parameter setting unit 206 has received an instruction signal. When the wireless communication apparatus 200 has received the instruction signal, the process advances to step S1008; otherwise, the process advances to step S1009.

In step S1008, the wireless unit 203 receives the low-speed mode parameters from the low-speed mode parameter setting unit 206 and switches the wireless communication from high-speed mode to low-speed mode.

In step S1009, the wireless unit 203 transmits a response packet to the communication partner.

It is determined in step S1010 whether or not the wireless unit 203 completes data packet receiving. If data packet receiving is not complete, n is incremented by one in step S1011. The process then returns to step S1004 to repeat processing in steps S1004 to S1009 until data packet receiving is complete. The operation on the side of the terminal 101 has ended.

The operation on the side of the station 102 will be described in detail with reference to the flowchart of FIG. 10(b).

In step S1051, the wireless unit 203 sets the wireless communication in high-speed mode in accordance with the high-speed mode parameters from the high-speed mode parameter setting unit 202.

In step S1052, the wireless unit 203 transmits a connection request packet to the communication partner (in this case, the terminal 101).

In step S1053, it is determined whether or not the wireless unit 203 has received a content request packet from the communication partner normally. If the content request packet has been received normally, the process advances to step S1054; otherwise, the process returns to step S1052 to repeat the operation described above.

In step S1054, n is set to 1.

In step S1055, the wireless unit 203 sequentially transmits the data packets from n to the communication partner. When processing in step S1055 is performed for the first time, n is 1.

In step S1056, it is determined whether or not the wireless unit 203 has received the response packet from the communication partner normally. If the response packet has been received normally, the process advances to step S1057; otherwise, processing in step S1055 is repeated until the response packet has been received.

In step S1057, it is determined whether or not the wireless unit 203 has switched the mode from high-speed mode to low-speed mode. This determination is performed, for example, by determining whether the PHY head shown in FIG. 3 indicates low-speed mode. If the flag indicates low-speed mode, the process advances to step S1058. The wireless unit 203 receives the low-speed mode parameters from the low-speed mode parameter setting unit 206 to switch the wireless communication from high-speed mode to low-speed mode. If the flag does not indicate low-speed mode, the process advances to step S1059.

In step S1059, it is determined whether or not the wireless unit 203 has transmitted all the data. If not all the data have been completely transmitted, n is incremented by one in step S1060, and the processing in steps S1055 to S1058 is repeated. When all the data have been completely transmitted, the process returns to the initial state (step S1051).

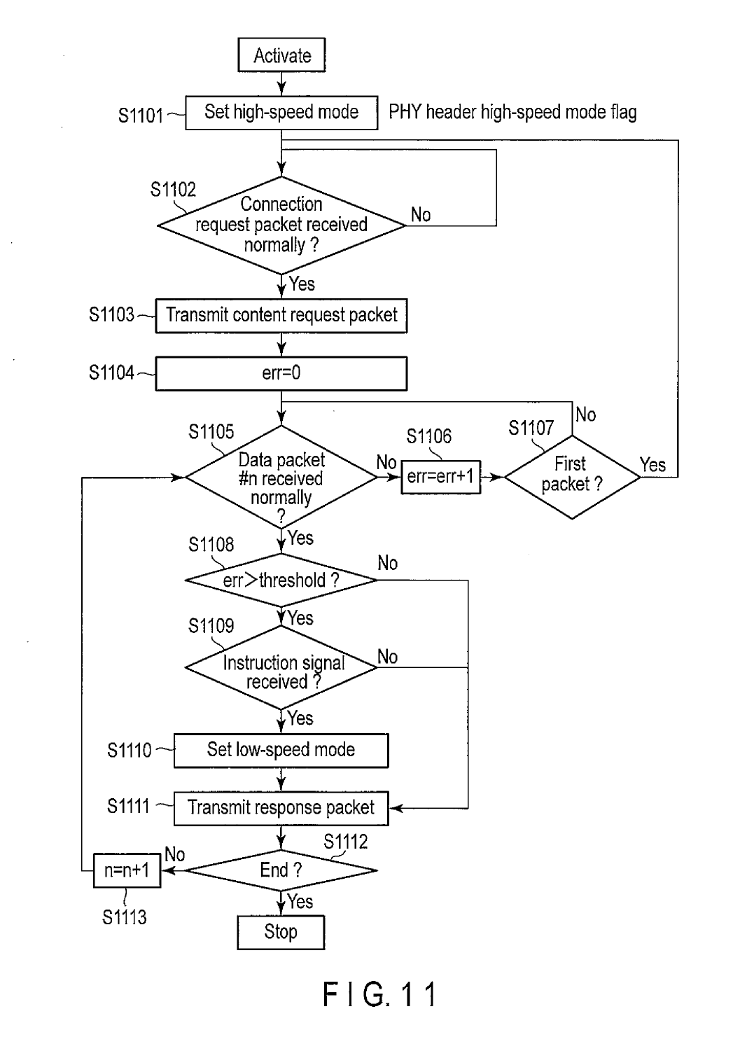

The operation of the terminal for threshold value determination using the receiving packet error count will be described in detail as a detailed example of signal degradation degree with reference to FIG. 11.

Processing from step S1101 to step S1103 is the same as processing from step S1001 to step S1003 in FIG. 10(a), and a detailed description thereof will not be repeated.

In step S1104, an error counter (err) is set to 0.

In step S1105, it is determined whether or not the wireless unit 203 has received a data packet from the communication partner normally. If the data packet has been received normally, the process advances to step S1108; otherwise, the process advances to step S1106.

In step S1106, the error counter is incremented by one.

It is determined in step S1107 whether or not the data packet which has not been received normally by the wireless unit 203 is the first data packet. If the data packet is the first one, the process returns to step S1102, and processing from step S1102 to step S1106 is repeated. If the data packet which has not been received normally is not the first data packet, processing in step S1105 is repeated until the data packet has been received normally. That is, the error count is continuously incremented if a data packet (#2) or subsequent data packet other than the first data packet (#1) cannot be received.

In step S1108, the threshold determination unit 205 compares the threshold value from the threshold setting unit 204 with the count of the error counter for the data packet received from the wireless unit 203 to determine whether or not the count of the error counter is larger than the threshold value. If the count of the error counter is larger than the threshold value, the process advances to step S1109; otherwise, the process advances to step S1111.

It is determined in step S1109 whether or not the low-speed mode parameter setting unit 206 has received an instruction signal. If the low-speed mode parameter setting unit 206 has received the instruction signal, the process advances to step S1110. If the low-speed mode parameter setting unit 206 has not received the instruction signal, the process advances to step S1111.

In step S1110, the wireless unit 203 receives the low-speed mode parameters from the low-speed mode parameter setting unit 206 to switch the wireless communication from high-speed mode to low-speed mode.

In step S1111, the wireless unit 203 transmits the response packet to the communication partner.

In step S1112, it is determined whether or not the wireless unit 203 completely performs data reception. If data reception is not complete, the n is incremented by one in step S1113, and then process returns to step S1105. Processing from step S1105 to step S1111 is repeated until all the data have been received.

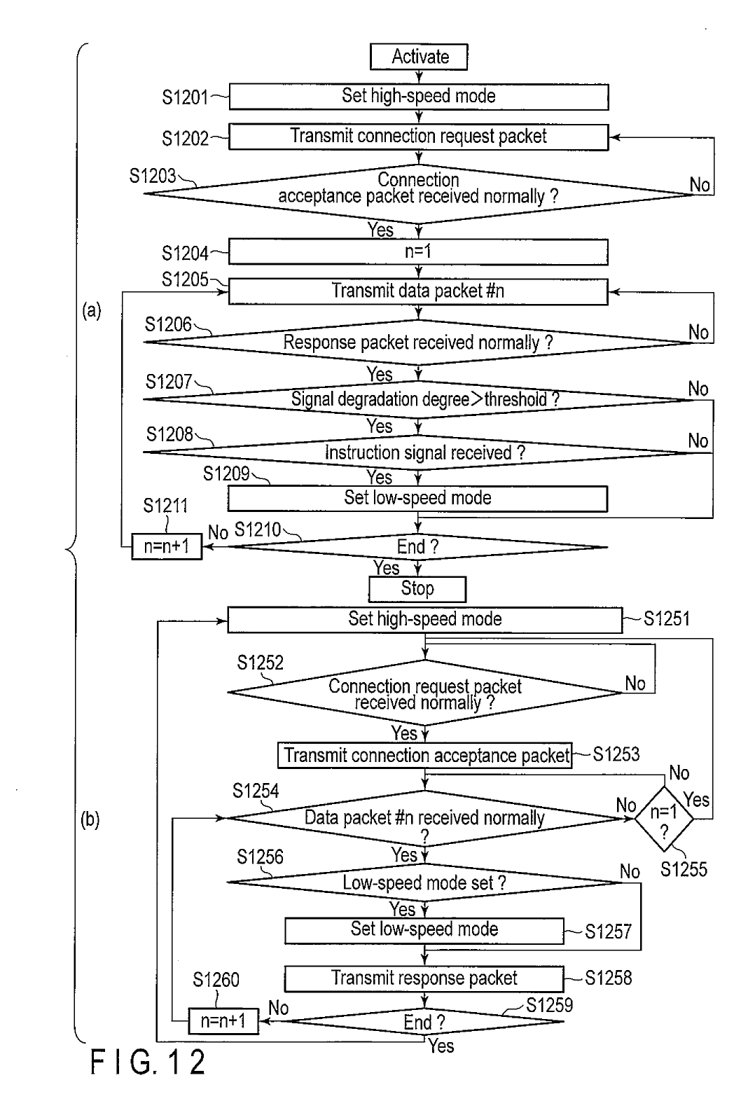

The operations of the terminal 101 and the station 102 when data is transferred from the terminal 101 to the station 102 will be described in detail with reference to the flowcharts in FIGS. 12(a) and 12(b). First of all, the operation of the terminal 101 will be described with reference to the flowchart of FIG. 12(a).

As in FIG. 10(a), the terminal 101 is activated when the activation unit 201 receives one of the close-proximity detection signal and a button-press detection signal.

In step S1201, the wireless unit 203 sets to perform wireless communication in high-speed mode in accordance with the high-speed mode parameters from the high-speed mode parameter setting unit 202.

In step S1202, the wireless unit 203 transmits a connection request packet to the communication partner.

In step S1203, it is determined whether or not the wireless unit 203 has received a connection acceptance packet transmitted from the communication partner normally. If the connection acceptance packet has been received normally, the process advances to step S1204; otherwise, the process returns to step S1202. Step S1202 is repeated until the connection acceptance packet from the communication partner has been received normally.

In step S1204, n is set to 1.

In step S1205, the wireless unit 203 transmits a data packet (#n) to the communication partner. When processing in step S1205 is performed for the first time, n is 1.

In step S1206, it is determined whether the wireless unit 203 has received a response packet from the communication partner normally. If the response packet has been received normally, the process advances to step S1207; otherwise, the process returns to step S1205 to retransmit the data packet.

In step S1207, the threshold determination unit 205 compares the signal degradation degree from the wireless unit 203 with the threshold value from the threshold setting unit 204 to determine whether or not the signal degradation degree is higher than the threshold value. If the signal degradation degree is higher than the threshold value, the process advances to step S1208; otherwise, the process advances to step S1210.

It is determined in step S1208 whether or not the low-speed mode parameter setting unit 206 has received an instruction signal. If the wireless communication apparatus 200 has received the instruction signal, the process advances to step S1209; otherwise, the process advances to step S1210.

In step S1209, the wireless unit 203 receives the low-speed mode parameters from the low-speed mode parameter setting unit 206 to switch the wireless communication from high-speed mode to low-speed mode.

In step S1210, it is determined whether or not the wireless unit 203 has transmitted all the data. If not all the data have been completely transmitted, n is incremented by one in step S1211, and the process returns to step S1205. Processing from step S1205 to step S1209 is repeated until all the data have been transmitted. The operation on the side of the terminal 101 has then ended.

The operation of the station 102 will be described in detail with reference to the flowchart in FIG. 12(b).

In step S1251, the wireless unit 203 sets to perform the wireless communication in high-speed mode in accordance with the high-speed mode parameters from the high-speed mode parameter setting unit 202.

In step S1252, it is determined whether or not the wireless unit 203 has received a connection request packet from the communication partner normally. If the connection request packet has been received normally, the process advances to step S1253; otherwise, processing in step S1252 is repeated until the connection request packet has been received normally.

In step S1253, the wireless unit 203 transmits a connection acceptance packet.

In step S1254, it is determined whether or not the wireless unit 203 has received the nth data packet from the communication partner normally. If the data has been received normally, the process advances to step S1256; otherwise, the process advances to step S1255. When processing in step S1254 is performed for the first time, n is 1.

In step S1255, it is determined whether or not the data packet which has been received by the wireless unit 203 is the first data packet (data packet #1). If the data packet is the first one, the process returns to step S1252 to perform processing from step S1252 to step S1254 in the same manner as described above. If the data packet is not the first one, the process returns to step S1254 to repeat the same processing until the data packet has been received.

In step S1256, it is determined whether or not the wireless unit 203 switches the wireless communication from high-speed mode to low-speed mode. This determination is performed by determining whether or not the flag of the PHY header shown in FIG. 3 indicates low-speed mode. If the flag indicates low-speed mode, the process advances to step S1257. The wireless unit 203 receives the low-speed parameters from the low-speed mode parameter setting unit 206 to switch the wireless communication from high-speed mode to low-speed mode. If the flag does not indicate low-speed mode, the process advances to step S1258.

In step S1258, the wireless unit 203 transmits a response packet to the communication partner.

In step S1259, the wireless unit 203 determines whether or not all the data packets have been received. If not all the data packets have been completely received, n is incremented by one in step S1260. The process returns to step S1254 to repeat processing from step S1254 to step S1258 in the same manner as described above. Upon receiving all the data, the process returns to the initial state (step S1251).

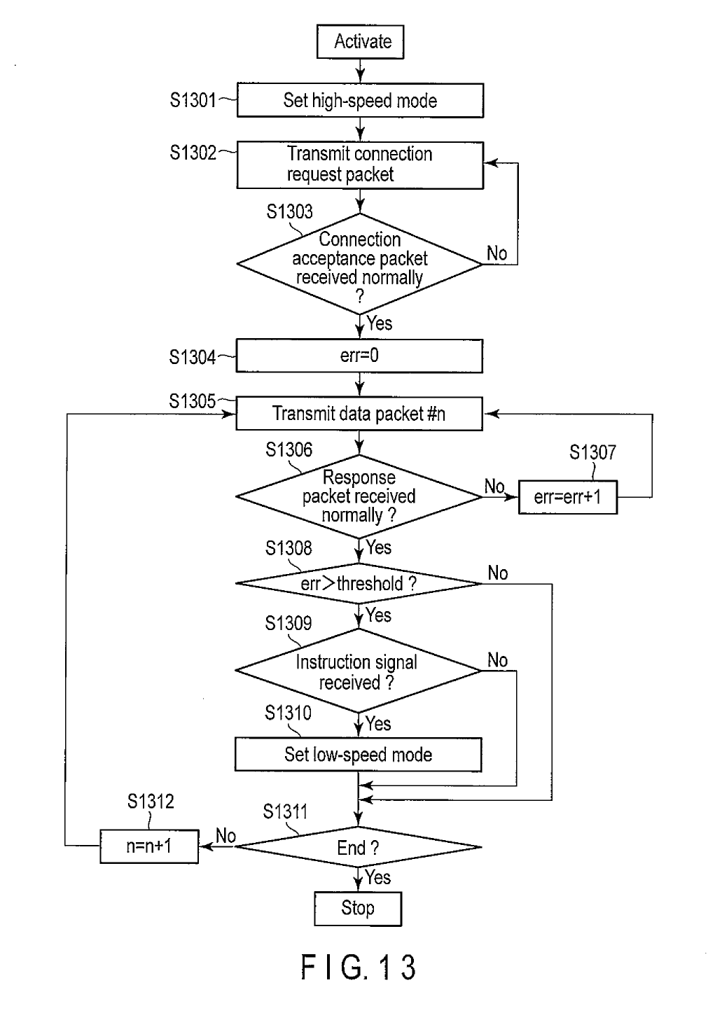

The operation of the terminal which performs threshold value determination using the transmitting packet error count as the signal degradation degree when transmitting data will be described in detail with reference to FIG. 13.

Processing from step S1301 to step S1303 is the same as the processing from step S1201 to step S1203 in FIG. 12(a), and a description thereof will not be repeated.

In step S1304, the error counter (err) is set to 0.

In step S1305, the wireless unit 203 transmits a data packet (#n) to the communication partner. When processing in step S1205 is performed for the first time, n is 1.

In step S1306, the wireless unit 203 determines whether or not a response packet has been received from the communication partner normally. If the response packet has been received normally, the process advances to step S1308; otherwise, the error counter is incremented by one in step S1307. The process then returns to step S1305 to retransmit the data packet.

In step S1308, the threshold determination unit 205 compares the threshold value from the threshold setting unit 204 with the count of the error counter for the response packet received from the wireless unit 203 to determine whether or not the count of the error counter is larger than the threshold value. If the count of the error counter is larger than the threshold value, the process advances to step S1309; otherwise, the process advances to step S1311.

It is determined in step S1309 whether or not the low-speed mode parameter setting unit 206 has received an instruction signal. If the low-speed mode parameter setting unit 206 has received the instruction signal, the process advances to step S1310; otherwise, the process advances to step S1311.

In step S1310, the wireless unit 203 receives the low-speed mode parameters from the low-speed mode parameter setting unit 206 to switch the wireless communication from high-speed mode to low-speed mode.

In step S1311, it is determined whether or not the wireless unit 203 has completely transmitted all the data. If not all the data have been completely transmitted, n is incremented in step S1312. The process returns to step S1305 to repeat processing from step S1305 to step S1309 until all the data have been completely transmitted. The operation on the side of the terminal 101 has then ended.

According to the first embodiment as described above, if a multipath is generated in close-proximity wireless communication, the activation method using either the close-proximity detection signal or the instruction signal can cope with the instantaneous transfer (high-speed mode). At the same time, if the detection signal is the instruction signal, the mode is switched to low-speed mode placing importance on stability rather than instantaneous transfer if the signal quality has degraded.

### SECOND EMBODIMENT

This embodiment is different from the first embodiment in that the mode is switched from high-speed mode to low-speed mode if a predetermined period (time interval) has elapsed using a timer.

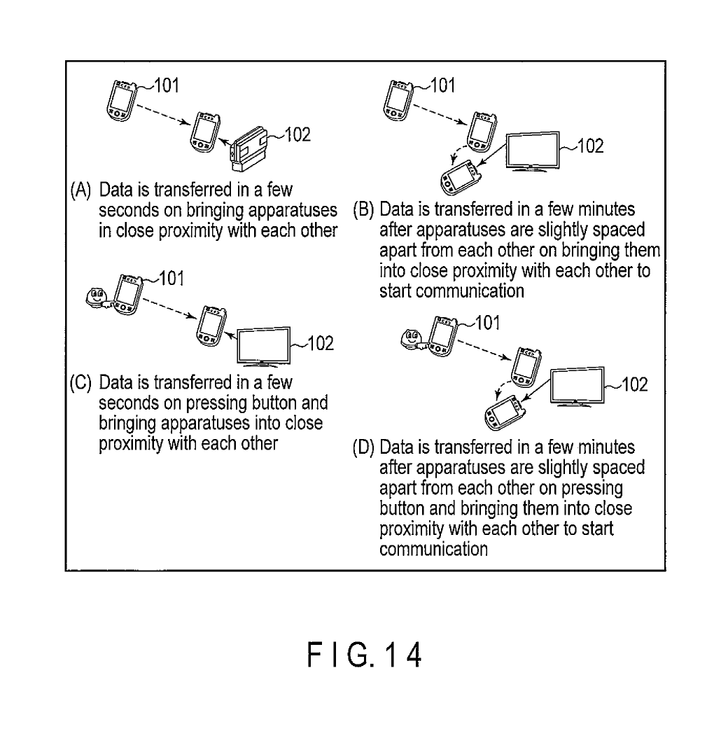

An example of using a wireless communication apparatus according to the second embodiment will be described in detail with reference to FIG. 14.

A and D are the same as those of FIG. 1, and a description thereof will not be repeated. B is a case in which data is transferred in a few minutes after the terminal 101 is slightly spaced apart from the station upon bringing the terminal 101 into close proximity to the station 102 and pressing the button of the terminal 101 to start communication. The data is transferred in high-speed mode because the close-proximity detection between the apparatuses is short. If it takes a few minutes until the end of data transfer, the initial positional relationship between the terminal 101 and the station 102 may change. The data is desirably transferred in low-speed mode. Case B assumes this situation.

C is a case in which instantaneous transfer is performed upon bringing the terminal 101 into close proximity to the station 102 after pressing the button of the terminal 101. Since the user presses the button of the terminal 101 and the terminal 101 is brought into close-proximity to the station 102, the close-proximity detection between the apparatuses may be long at the start of communication, and the communication state may be unstable in high-speed mode. The data may be desirably transferred in low-speed mode. However, since the close-proximity detection between the apparatuses gradually becomes short, the data can be transferred in high-speed mode. Case C assumes this situation.

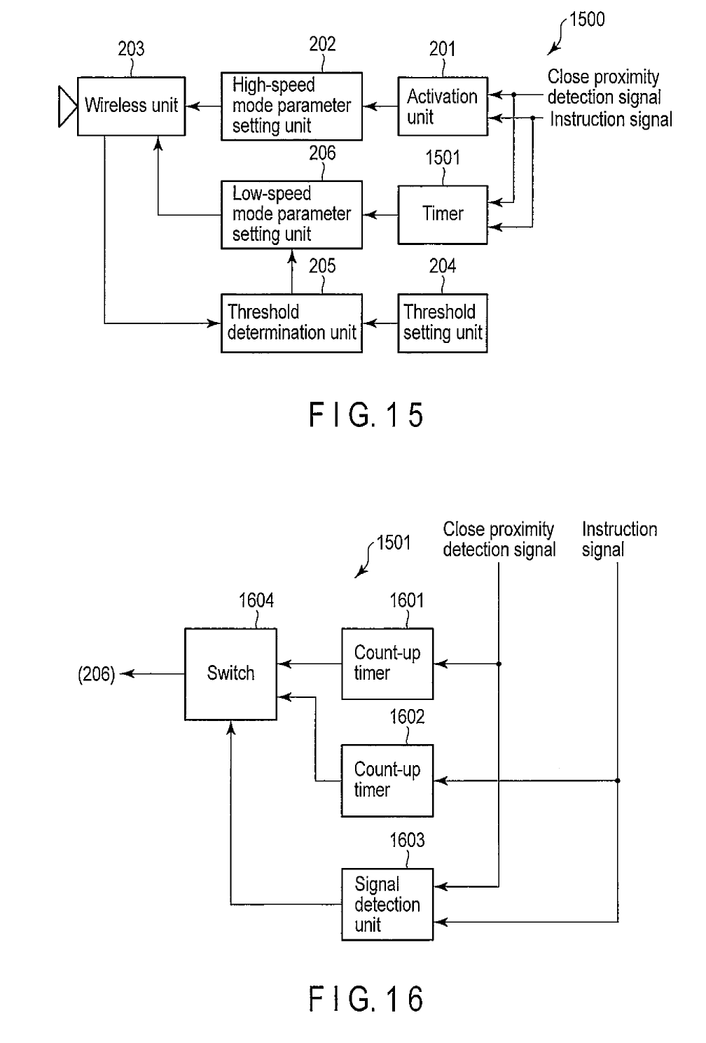

The arrangement of the wireless communication apparatus according to the second embodiment will be described in detail with reference to FIG. 15.

A wireless communication apparatus 1500 according to this embodiment includes a timer 1501 in addition to the same arrangement as in the wireless communication apparatus 200 of the first embodiment.

An activation unit 201, high-speed mode parameter setting unit 202, wireless unit 203, threshold setting unit 204, and threshold determination unit 205 operate in the same manner as in the first embodiment.

Timer 1501 is reset upon receiving a close-proximity detection signal or user operation detection signal. If a time greater than an interval set in timer 1501 has elapsed, a flag is set and sent to a low-speed mode parameter setting unit 206.

The operation of the low-speed mode parameter setting unit 206 is different from that of the low-speed mode parameter setting unit 206 of the first embodiment in that the low-speed mode parameter setting unit 206 receives the flag from timer 1501 and outputs parameter setting values of low-speed mode.

An example of the arrangement of timer 1501 will be described in detail with reference to FIG. 16.

Timer 1501 includes count-up timers 1601 and 1602, a signal determination unit 1603, and a switch 1604.

The count-up timers 1601 and 1602 are a close-proximity detection signal timer and an instruction signal timer, respectively.

Upon receiving the close-proximity detection signal, the count-up timer 1601 is reset and measures the time until the elapse of a close-proximity detection signal interval T_{SNS}. If the count value exceeds interval T_{SNS}, timer 1601 sets a flag.

Upon receiving the instruction signal, the count-up timer 1602 is reset in and measures the time until the elapse of an instruction signal interval T_{USR}. If the count value exceeds interval T_{USR}, timer 1602 sets a flag.

The signal determination unit 1603 determines whether or not a wireless communication apparatus 1500 has received a close-proximity detection signal or an instruction signal.

The switch 1604 sends a flag from the count-up timer 1601 to the low-speed mode parameter setting unit 206 based on the determination result received from the signal determination unit 1603 if the determination result indicates the close-proximity detection signal. Conversely, if the determination result indicates the instruction signal, the count-up timer 1602 sends the flag to the low-speed mode parameter setting unit 206.

The low-speed mode parameter setting unit 206 may store intervals T_{SNS} and T_{USR} in advance. If the counts of the count-up timers 1601 and 1602 reach intervals T_{SNS} and T_{USR}, respectively, the count-up timers 1601 and 1602 may send flags to the low-speed mode parameter setting unit 206, and the low-speed mode parameter setting unit 206 may determine a flag indicating the close-proximity detection signal or instruction signal.

Alternatively, only one count-up timer may be used and count time without setting any interval. Based on the determination result from the signal determination unit 1603, the switch 1604 sends a flag to the low-speed mode parameter setting unit 206 if the count reaches one of intervals T_{SNS} and T_{USR}. For example, upon receiving the determination result indicating the instruction signal from the signal determination unit 1603 to the switch 1604, a flag is set when the count value of the count-up timer reaches interval T_{USR}.

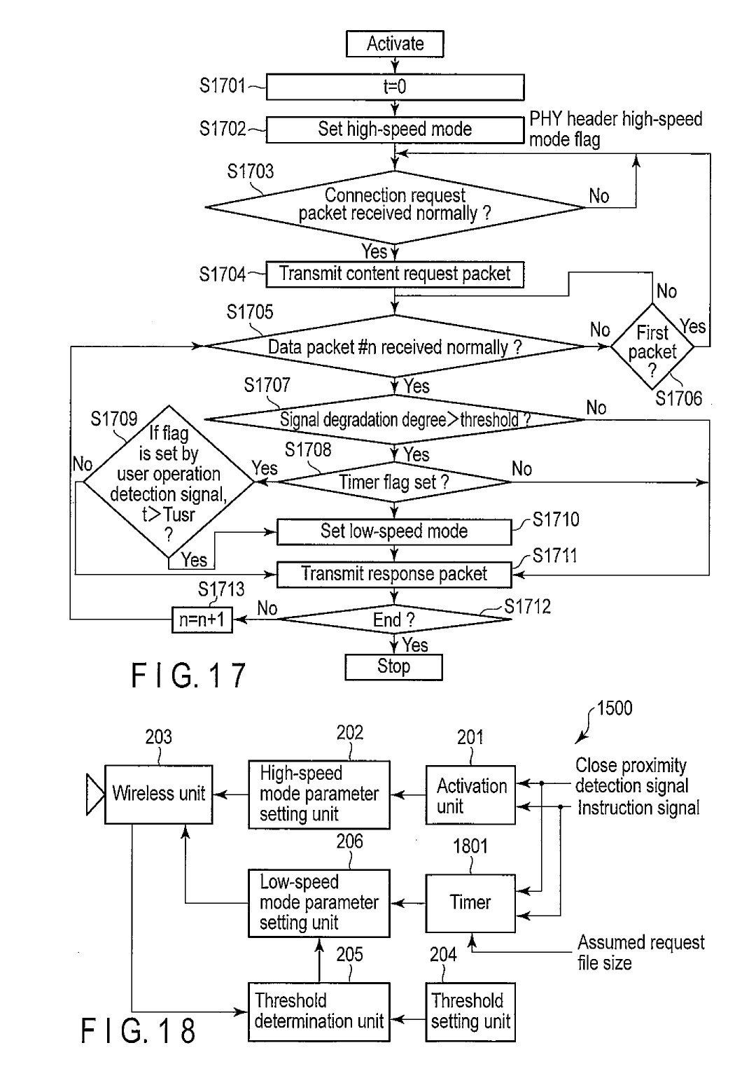

The operation of the terminal according to the wireless communication apparatus of this embodiment will be described in detail with reference to the flowchart of FIG. 17. The terminal 101 is activated if the activation unit 201 receives a close-proximity detection signal or instruction signal.

In step S1701, when timer 1501 receives one of the close-proximity detection signal and instruction signal, the corresponding count-up timer 1601 or 1602 is reset, that is, t is set to 0, and then the timer starts counting the time.

Processing from step S1702 to step S1707 is the same as in that from step S1001 to step S1006 in FIG. 10(a), and a description thereof will not be repeated.

In step S1708, it is determined whether or not a timer flag is set in the low-speed mode parameter setting unit 206. If the flag is set, the process advances to step S1709; otherwise, the process advances to step S1711.

In step S1709, if the low-speed mode parameter setting unit 206 receives the instruction signal, it is determined whether or not the count value t of the timer is larger than interval T_{USR}. If the count value t of the timer is larger than interval T_{USR}, the process advances to step S1710; otherwise, the process advances to step S1711. Note that if the low-speed mode parameter setting unit 206 receives only the close-proximity detection signal, the process advances to step S1710 without performing determination processing in step S1709.

Processing from step S1710 to step S1713 is the same as that from step S1008 to step S1011 in FIG. 10(a), and a description thereof will not be repeated. In this manner, it is possible to switch the wireless communication from high-speed mode to low-speed mode in accordance with an interval preset by the timer.

Note that the relationship between intervals T_{SNS} and T_{USR} is defined as T_{SNS}<T_{USR}. Setting the interval of the instruction signal greater than the interval of the close-proximity detection signal allows to prevent unwanted switching to low-speed mode in a situation wherein the signal quality in communication upon pressing the button greatly varies, as shown in FIG. 14.

The interval of timer 1501 may be changed by a requested file size.

An example of the arrangement of a wireless communication apparatus in which the timer interval is changed by the requested file size will be described in detail with reference to FIG. 18.

A wireless communication apparatus 1800 is different from the wireless communication apparatus 1500 shown in FIG. 15 in that a timer 1801 shown in FIG. 18 sets the interval based on an predicted value of a data size (amount of data) in wireless communication. Prolonging the interval in accordance with the data size allows to perform communication while maintaining the balance between instantaneous transfer and stability.

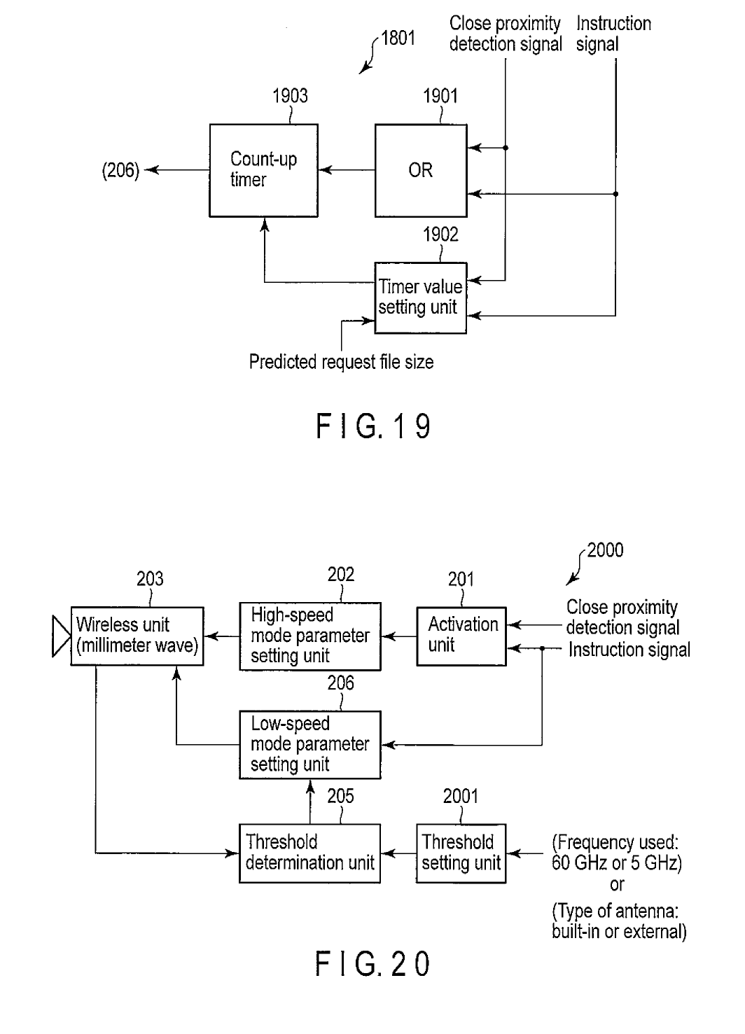

An example of the arrangement of timer 1801 will be described in detail with reference to FIG. 19.

Timer 1801 includes an OR gate 1901, timer value setting unit 1902, and count-up timer 1903.

The OR gate 1901 receives a close-proximity detection signal or instruction signal and sends the received detection signal to the count-up timer 1903.

The timer value setting unit 1902 receives an externally predicted request file size, and an external close-proximity detection signal or instruction signal, and sets an interval which matches the predicted file size. More specifically, if the predicted file size is large, it takes long time to completely transfer a file, so that the interval is set long. Conversely, if the predicted file size is small, the interval is set short because instantaneous transfer is possible.

The count-up timer 1903 receives the detection signal from the OR gate 1901 and the interval from the timer value setting unit 1902. Upon receiving the detection signal, the timer is reset to start counting the time. If the count value reaches the interval, the count-up timer 1903 sends a flag to the low-speed mode parameter setting unit 206.

According to the second embodiment as described above, if a predetermined period of time (interval) has elapsed using the timer, the mode is switched from high-speed mode (high-speed transmission) to low-speed mode (low-speed transmission) to cope with different applications having importance on instantaneous transfer and stability.

### THIRD EMBODIMENT

The arrangement of a wireless communication apparatus according to a third embodiment will be described in detail with reference to FIG. 20.

The wireless communication apparatus according to the third embodiment is different from the wireless communication apparatus 200 of the first embodiment in that a threshold setting unit 2001 sets a threshold value based on a carrier frequency or a type of antenna used in a wireless unit 203.

First of all, threshold value setting based on a carrier frequency will be described below. Generally, a propagation loss is high at a high carrier frequency, resulting in unstable communication. The threshold setting unit 2001 sets a low threshold value for a signal degradation degree to quickly switch the mode to low-speed mode, thereby performing stable communication even at a high carrier frequency.

Threshold setting based on a type of antenna will be described below. A built-in antenna generates a larger number of multipaths caused by reflection in the apparatus than an external antenna to result in unstable communication. FIG. 21 shows the measurement results of maximum delay times of the delay waves caused by the multipaths. The measurement values are obtained if a communication close-proximity detection falls within 10 cm in the 60-GHz band. Ant-Ant indicates that external antennas face each other. Ant-Camera indicates that an external antenna faces an antenna built into a camera. Ant-PC indicates that an external antenna faces an antenna built into a notebook computer. Camera-PC indicates that an antenna built into a digital camera faces an antenna built into a notebook computer. As can be obvious from FIG. 21, the built-in antenna has a greater maximum delay time (maximum of about 2 ns) than the external antenna.

The threshold setting unit 2001 sets a low threshold value for signal degradation degree based on an arrangement in which an antenna of wireless communication apparatus 2000 is built into an apparatus, thereby quickly switching the wireless communication to low-speed mode, thereby performing stable communication even with the built-in antenna.

An example of a demodulator used in a wireless unit according to third embodiment will be described in detail with reference to FIG. 22. A demodulator 2200 includes a variable gain amplifier 2201, DC cut filter 2202, analog-to-digital converter 2203, OFDM demodulation unit 2204, and gain control unit 2205.

A signal received by an antenna (not shown) is converted into an analog baseband signal by an RF circuit (not shown).

The variable gain amplifier 2201 then adjusts a signal level.

The DC cut filter 2202 removes an unnecessary DC component. Processing in the DC cut filter 2202 is important for a decrease in a predetermined number of bits of the subsequent analog-to-digital converter 2203, i.e., reduction of power consumption of the analog-to-digital converter 2203.

The analog-to-digital converter 2203 receives an analog signal from the DC cut filter 2202 and digitizes it.

The OFDM demodulation unit 2204 receives the digital signal from the analog-to-digital converter 2203 and demodulates it.

The gain control unit 2205 controls the variable gain amplifier 2201 based on the level of the reception signal. The gain control processing is performed using preambles 302 and 306 shown in FIG. 3.

The high-pass cutoff frequency of the DC cut filter 2202 is set about ¼ the subcarrier interval of the OFDM signal. A time interval in which an amplified signal becomes stable after the gain control unit 2205 changes the gain of the variable gain amplifier 2201, that is, a transient response time is in inverse proportion to the high-pass cutoff frequency. A higher high-pass cutoff frequency shortens the transient response time and the preamble. A shorter preamble is important to perform high-speed transmission. Note that OFDM does not generally use a DC component subcarrier and thus employs a null subcarrier scheme. In the example shown in FIG. 22, one null subcarrier of a DC component is used. However, three null subcarriers may be used.

According to the third embodiment as described above, if a millimeter wave wireless apparatus is built into an apparatus to perform close-proximity wireless communication, the mode is switched between high-speed mode and low-speed mode in data transfer in consideration of generation of the multipath caused by reflection in the apparatus, thereby performing communication having a good balance between instantaneous transfer and transfer having importance on stability.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus, comprising:
a determination unit configured to determine whether or not a signal degradation degree of a wireless communication is higher than a threshold value, the signal degradation degree indicating a degradation degree of a signal quality;
a first setting unit configured to set first parameters if communicating with a communication partner, the first parameters relating to a first data rate and a first communication robustness;
a second setting unit configured to set second parameters if an instruction signal is received from a upper layer and if the signal degradation degree is higher than the threshold value during performing the wireless communication with the communication partner using the first parameters, the second parameters relating to a second data rate and a second communication robustness, the second data rate being lower than the first data rate, the second communication robustness being higher than the first communication robustness; and
a wireless unit configured to communicate with the communication partner using one of the first parameters and the second parameters.

2. The apparatus according to claim 1, further comprising a third setting unit configured to set the threshold value,
wherein the third setting unit sets a first threshold value to be lower than a second threshold value, the first threshold value being set if an antenna connected to the apparatus is built into the apparatus, the second threshold value being set if the antenna is built outside the apparatus.

3. The apparatus according to claim 1, wherein a carrier frequency used in the wireless communication is in a millimeter waveband, and if an antenna is built into the apparatus, orthogonal frequency division multiplexing (OFDM) of 64-point fast Fourier transform (FFT) size is used one of the first parameters.

4. A wireless communication apparatus, comprising:
a determination unit configured to determine whether or not a signal degradation degree of a wireless communication is higher than a threshold value, the signal degradation degree indicating a degradation degree of a signal quality;
a first setting unit configured to set first parameters if communicating with a communication partner, the first parameters relating to a first data rate and a first communication robustness;
a timer configured to measure a time until an elapse of a first interval upon receiving one of a instruction signal from upper layer and a close-proximity detection signal, the close-proximity detection signal indicating that a communication partner falls within a distance;
a second setting unit configured to set second parameters if the signal degradation degree is higher than the threshold value and if the time exceeds the first interval, the second parameters relating to a second data rate and a second communication robustness, the second data rate being lower than the first data rate, the second communication robustness being higher than the first communication robustness; and
a wireless unit configured to communicate with the communication partner using one of the first parameters and the second parameters.

5. The apparatus according to claim 4, wherein a carrier frequency used in the wireless communication is in a millimeter waveband, and if an antenna is built into the apparatus, orthogonal frequency division multiplexing (OFDM) of 64-point fast Fourier transform (FFT) size is used one of the first parameters.

6. The apparatus according to claim 4, wherein the timer measures a second interval upon detecting the close-proximity detection signal, measures a third interval upon detecting the instruction signal,
if the close-proximity detection signal is only received, the timer sets the second interval as the first interval and measures a time,
if the instruction signal is only received, the timer sets the third interval as the first interval and measures a time,
if both the close-proximity detection signal and the instruction signal are received, the timer sets the third interval as the first interval and measures a time.

7. The apparatus according to claim 4, wherein the timer sets the first interval such that the larger a predicted amount of data, the greater the first interval.

8. The apparatus according to claim 6, the timer sets the third interval greater than the second interval.

9. A wireless communication method, comprising:
determining whether or not a signal degradation degree of a wireless communication is higher than a threshold value, the signal degradation degree indicating a degradation degree of a signal quality;
setting first parameters if communicating with a communication partner, the first parameters relating to a first data rate and a first communication robustness;
setting second parameters if an instruction signal is received from a upper layer and if the signal degradation degree is higher than the threshold value during performing the wireless communication with the communication partner using the first parameters, the second parameters relating to a second data rate and a second communication robustness, the second data rate being lower than the first data rate, the second communication robustness being higher than the first communication robustness; and
communicating with the communication partner using one of the first parameters and the second parameters.

10. The method according to claim 9, further comprising setting the threshold value,
wherein the setting the threshold value sets a first threshold value to be lower than a second threshold value, the first threshold value being set if an antenna connected to the apparatus is built into the apparatus, the second threshold value being set if the antenna is built outside the apparatus.

11. The method according to claim 9, wherein a carrier frequency used in the wireless communication is in a millimeter waveband, and if an antenna is built into the apparatus, orthogonal frequency division multiplexing (OFDM) of 64-point fast Fourier transform (FFT) size is used one of the first parameters.
